(19) United States
(12) Patent Application Publication
(10) Pub. No.: US 2025/0244286 A1
(43) Pub. Date: Jul. 31, 2025

(54) ELECTROPHORESIS DEVICE

(71) Applicant: SHANGHAI TANON LIFE SCIENCE CO.,LTD, Shanghai (CN)

(72) Inventors: Chengwei MENG, Shanghai (CN); Zhou YANG, Shanghai (CN); Xinyuan GUO, Shanghai (CN)

(73) Assignee: SHANGHAI TANON LIFE SCIENCE CO.,LTD, Shanghai (CN)

(21) Appl. No.: 18/669,601

(22) Filed: May 21, 2024

(30) Foreign Application Priority Data
Jan. 29, 2024 (CN) 202410123857.6

(51) Int. Cl. G01N 27/447

(52) U.S. Cl. CPC G01N 27/44704; G01N 27/44756

(57) ABSTRACT

An electrophoresis device includes: an electrophoresis tank body provided with a first chamber; a detachable electrode holder located in the first chamber of the electrophoresis tank body and provided with a positive electrode wire and a negative electrode wire for forming a uniform electric field; a gel plate coated with a precast gel and detachably located at a side of a first experimental port of the electrode holder to seal the first experimental port of the electrode holder; and a connecting frame provided at a side of the electrophoresis tank body to connect two adjacent electrophoresis tank bodies. The electrode holder is provided with a plurality of first wiring terminals. The first wiring terminals are respectively electrically connected to the positive electrode wire and the negative electrode wire, to allow a series or parallel connection of the circuits between the two adjacent electrophoresis tank bodies.

### CROSS REFERENCE TO THE RELATED APPLICATIONS

This application is based upon and claims priority to Chinese Patent Application No. 202410123857.6, filed on Jan. 29, 2024, the entire contents of which are incorporated herein by reference.

### TECHNICAL FIELD

The present disclosure belongs to the technical field of electrophoresis tanks for biological protein gels, and in particular relates to an electrophoresis device.

### BACKGROUND

In a molecular biology experiment, it is indispensable to detect an experimental result by gel electrophoresis, and an electrophoresis device is an indispensable experimental tool in the experiment.

Typically, in the prior art, gel separation experiments can only be conducted in single electrophoresis tanks, but the single electrophoresis tank cannot meet the requirements for separation experiments of a plurality of precast gels. The separation experiments of a plurality of precast gels have high sealing requirements for the electrophoresis tank. Once the buffer solution leaks, it will lead to inaccurate experimental results. Meanwhile, if single electrophoresis tanks are simply stacked, the distribution in the electrophoresis tanks is prone to disorder, and require connection to a plurality of power lines or provision of a plurality of power sources based on the prior art. This will result in an increase in equipment or in complex wiring connections, making it inconvenient for experimental personnel to operate. In the prior art, the electrode holder is integrally formed, and is provided with wiring slots on which positive and negative electrode wires are wound. When the positive or negative electrode wire or the support frame is damaged, it is often necessary to replace the whole electrode holder or re-wind the positive and negative electrode wires. However, the positive and negative electrode wires are generally platinum wires, which break easily and are not easy to wind, and it is costly to replace the whole holder.

### SUMMARY

The present disclosure provides an electrophoresis device. The present disclosure solves the following problems mentioned in the background. That is, a single electrophoresis tank cannot meet the experimental requirements of a plurality of precast gels, and when a plurality of precast gels are placed in a single electrophoresis tank, the buffer solution may leak. In addition, the positive and negative electrode wires are not easy to wind and it is costly to replace the whole electrode holder.

To achieve the above objective, the present disclosure adopts the following technical solutions:

An electrophoresis device includes:

an electrophoresis tank body, provided with a first chamber and a first opening configured to connect the first chamber to the outside;
an electrode holder, located in the first chamber of the electrophoresis tank body, and provided with a second chamber, a second opening connected to the second chamber, and a first experimental port connected to the second chamber, where the electrode holder is further provided with a positive electrode wire and a negative electrode wire, and the positive electrode wire and the negative electrode wire are configured to form a uniform electric field; and the positive electrode wire is partially located outside the second chamber, and the negative electrode wire is partially located inside the second chamber;
a gel plate, coated with a precast gel, and detachably provided on the electrode holder, where the gel plate is configured to seal the first experimental port of the electrode holder, such that the first chamber and the second chamber are independent of each other; and
a connecting frame, provided at a side of the electrophoresis tank body, and configured to connect two adjacent electrophoresis tank bodies, where the connecting frame is provided with a plurality of first wiring terminals; and the plurality of first wiring terminals are respectively electrically connected to the positive electrode wire and the negative electrode wire, and the first wiring terminals of the two adjacent electrophoresis tank bodies are correspondingly electrically connected, to allow a series or parallel connection of the circuits between the two adjacent electrophoresis tank bodies.

In some implementations, the electrode holder includes a support frame body, a positive electrode assembly, and a negative electrode assembly; the support frame body is provided with a first mounting groove adapted to the positive electrode assembly and a second mounting groove adapted to the negative electrode assembly; and the positive electrode assembly is detachably provided in the first mounting groove of the support frame body, and the negative electrode assembly is detachably provided in the second mounting groove of the support frame body.

In some implementations, the positive electrode assembly includes a positive electrode holder and a positive electrode wiring terminal provided on the positive electrode holder; the negative electrode assembly includes a negative electrode holder and a negative electrode wiring terminal provided on the negative electrode holder; the positive electrode wire is provided on the positive electrode holder and electrically connected to the positive electrode wiring terminal; and the negative electrode wire is provided on the negative electrode holder and electrically connected to the negative electrode wiring terminal.

In some implementations, the positive electrode holder is provided with a first wiring slot; the positive electrode wire includes a first insulating section and a first exposed section; and the first insulating section of the positive electrode wire is located in the first wiring slot, and the first exposed section of the positive electrode wire is fixed to the positive electrode holder.

In some implementations, the negative electrode holder is provided with a second wiring slot; the negative electrode wire includes a second insulating section and a second exposed section; the second insulating section of the negative electrode wire is located in the second wiring slot, and the second exposed section of the negative electrode wire is fixed to the negative electrode holder; and the second exposed section of the negative electrode wire and the first exposed section of the positive electrode wire are in a position correspondence and parallel to each other.

In some implementations, the positive electrode holder is provided with a first fixing structure, and the first exposed section of the positive electrode wire is fixed to the positive electrode holder through the first fixing structure; and the negative electrode holder is provided with a second fixing structure, and the second exposed section of the negative electrode wire is fixed to the negative electrode holder through the second fixing structure.

In some implementations, a distance between the second exposed section of the negative electrode wire and a bottom wall of the electrode holder is one-half of a depth of the second chamber of the electrode holder.

In some implementations, the positive electrode wire and the positive electrode holder are integrated, and the negative electrode wire and the negative electrode holder are integrated.

In some implementations, the connecting frame and the electrophoresis tank body are integrated.

In some implementations, the connecting frame and the electrophoresis tank body are detachably connected.

In some implementations, the connecting frame includes a clamping boss and a clamping groove adapted to the clamping boss; when the two adjacent electrophoresis tank bodies are connected, the clamping boss on the connecting frame of a first electrophoresis tank body is clamped into the clamping groove on the connecting frame of a second electrophoresis tank body; and alternatively, the clamping groove on the connecting frame of the first electrophoresis tank body is clamped onto the clamping boss on the connecting frame of the second electrophoresis tank body.

In some implementations, the electrophoresis tank body is inclined to allow the two adjacent electrophoresis tank bodies to be misaligned.

In some implementations, a connecting plate is provided between the connecting frame and the electrophoresis tank body; and the connecting plate is at a preset angle to the electrophoresis tank body such that the electrophoresis tank body is inclined relative to the connecting frame.

In some implementations, the clamping groove is provided with a first boss, and the clamping boss is provided with an adapted first slot; and when the two adjacent electrophoresis tank bodies are connected, the first boss of the first electrophoresis tank body is clamped into the first slot of the second electrophoresis tank body.

In some implementations, the first slot is arranged along a side of the connecting frame; and when the first boss on the connecting frame of the first electrophoresis tank body is clamped into the first slot on the connecting frame of the second electrophoresis tank body, the clamping boss on the connecting frame of the second electrophoresis tank body abuts against a side wall of the connecting frame of the first electrophoresis tank body.

In some implementations, the connecting frame is provided with a first mounting plate at a side of the clamping boss; the first mounting plate is provided with a plurality of second wiring terminals that are correspondingly electrically connected to the plurality of first wiring terminals and a first avoidance groove that is in a position correspondence with the first slot; and when the two adjacent electrophoresis tank bodies are connected, the first mounting plate on the connecting frame of the second electrophoresis tank body abuts against the connecting frame of the first electrophoresis tank body.

In some implementations, the connecting frame is provided with a first support plate at a side of the clamping groove; the first support plate is provided with a plurality of first through holes adapted to the plurality of second wiring terminals; and when the two adjacent electrophoresis tank bodies are connected, ends of the plurality of second wiring terminals on the first mounting plate of the second electrophoresis tank body respectively pass through the plurality of first through holes on the first support plate of the first electrophoresis tank body, and the first support plate abuts against a side wall of the adjacent connecting frame.

In some implementations, the electrophoresis device further includes a first tank cover; the first tank cover is detachably located on the first opening of the electrophoresis tank body, and the first tank cover is provided with a plurality of terminal caps; a pre-connection circuit is provided between the plurality of terminal caps; and the first wiring terminals, the positive electrode wiring terminal, and the negative electrode wiring terminal are inserted into the plurality of terminal caps in a one-to-one correspondence to achieve the series or parallel connection of the circuits between the two adjacent electrophoresis tank bodies.

In some implementations, first tank covers are provided in two different colors; and the first tank covers in the two different colors are correspondingly provided with different pre-connection circuits.

In some implementations, the electrophoresis tank body is a single gel tank structure; the first experimental port of the electrode holder is provided at a single side; a preset spacing is formed between the electrode holder and the electrophoresis tank body; and the gel plate is detachably provided within the preset spacing.

In some implementations, a first sealing groove is provided at a side of the first experimental port of the electrode holder; a first sealing strip is provided inside the first sealing groove; the first sealing strip partially protrudes from the first sealing groove; and when the gel plate is provided within the preset spacing, the first sealing strip is in a compressed state.

In some implementations, the first sealing strip is detachably provided in the first sealing groove; and a side of the first sealing strip away from a bottom wall of the electrophoresis tank body is provided with a clamping step.

In some implementations, the electrophoresis tank body is provided with a first clamping groove, and the electrode holder is provided with a first clamping boss; and when the first clamping boss of the electrode holder is clamped into the first clamping groove of the electrophoresis tank body, a side wall of the electrode holder abuts against a side wall of the electrophoresis tank body.

In some implementations, a pressure plate is provided between the gel plate and an inner wall of the electrophoresis tank body; and one side of the pressure plate abuts against the gel plate, and the other side of the pressure plate abuts against the inner wall of the electrophoresis tank body.

In some implementations, an outline structure of the pressure plate is identical to a structure of the first sealing groove, and the pressure plate is configured to cover the first sealing groove.

In some implementations, the pressure plate is provided with guide posts, and the electrode holder is provided with adapted guide holes; and alternatively, the pressure plate is provided with the guide holes, and the electrode holder is provided with the guide posts; and the guide posts are respectively inserted into the guide holes.

Compared with the prior art, the present disclosure has the following beneficial effects:

In the present disclosure, the connecting frame connects two adjacent electrophoresis tank bodies. The first wiring terminals and the second wiring terminals provided on the connecting frame, as well as the positive electrode wiring terminal and the negative electrode wiring terminal, are matched in a clamped manner with the first tank cover for circuit pre-setting to achieve a series or parallel connection of the circuits between the two adjacent electrophoresis tank bodies. The present disclosure provides a constant-voltage or constant-current mode to achieve the gel running experiment of a plurality of gel plates based on the experimental requirements. The electrode holder is divided into a support frame, a positive electrode assembly, and a negative electrode assembly. When a single component of the electrode holder is damaged, only the damaged component is replaced, without the need to replace the entire electrode holder, and the replacement method is simple and cost-effective.

Additional aspects and advantages of the present application will be partly provided in the following description, and partly become evident in the following description or understood through the practice of the present application.

### BRIEF DESCRIPTION OF THE DRAWINGS

FIG. 1 is a first three-dimensional diagram of a single electrophoresis device according to the present disclosure;

FIG. 2 is a second three-dimensional diagram of the single electrophoresis device according to the present disclosure;

FIG. 3 is a three-dimensional diagram of a connecting frame of the electrophoresis device according to the present disclosure;

FIG. 4 is a first three-dimensional structural diagram of an electrode holder of the electrophoresis device according to the present disclosure;

FIG. 5 is a first three-dimensional diagram of a support frame body of the electrode holder according to the present disclosure;

FIG. 6 is a second three-dimensional diagram of the support frame body of the electrode holder according to the present disclosure;

FIG. 7 is a three-dimensional structural diagram of a positive electrode holder of the electrode holder according to the present disclosure;

FIG. 8 is a top view of the positive electrode holder of the electrode holder according to the present disclosure;

FIG. 9 is a three-dimensional structural diagram of a negative electrode holder of the electrode holder according to the present disclosure;

FIG. 10 is a top view of the negative electrode holder of the electrode holder according to the present disclosure;

FIG. 11 is a three-dimensional structural diagram of an electrophoresis tank body according to the present disclosure.

FIG. 12 is an assembly diagram of a gel plate and the electrode holder according to the present disclosure;

FIG. 13 is an exploded view of the gel plate and the electrode holder according to the present disclosure;

FIG. 14 is a top view of the electrophoresis device according to the present disclosure;

FIG. 15 is a top view of the electrophoresis device according to a variation embodiment of the present disclosure;

FIG. 16 is a first three-dimensional structural diagram of a first sealing strip of the electrode holder according to the present disclosure;

FIG. 17 is a three-dimensional structural diagram of a plurality of electrophoresis devices that are spliced together according to the present disclosure;

FIG. 18 is a top view of the plurality of electrophoresis devices that are spliced together according to the present disclosure; and

FIG. 19 is a schematic diagram of series and parallel connections between circuits of the plurality of electrophoresis devices according to the present disclosure.

### DETAILED DESCRIPTION OF THE EMBODIMENTS

The present application is described in more detail below with reference to the specific drawings. It should be noted that in the description of the embodiment, unless otherwise specified, the terms such as “upper” and “lower” indicate the orientation or position relationships based on the drawings. These terms are merely intended to facilitate and simplify the description of the present application, rather than to indicate or imply that the present application must have a specific orientation and must be constructed and operated in a specific orientation. Therefore, these terms should not be construed as a limitation to the present application.

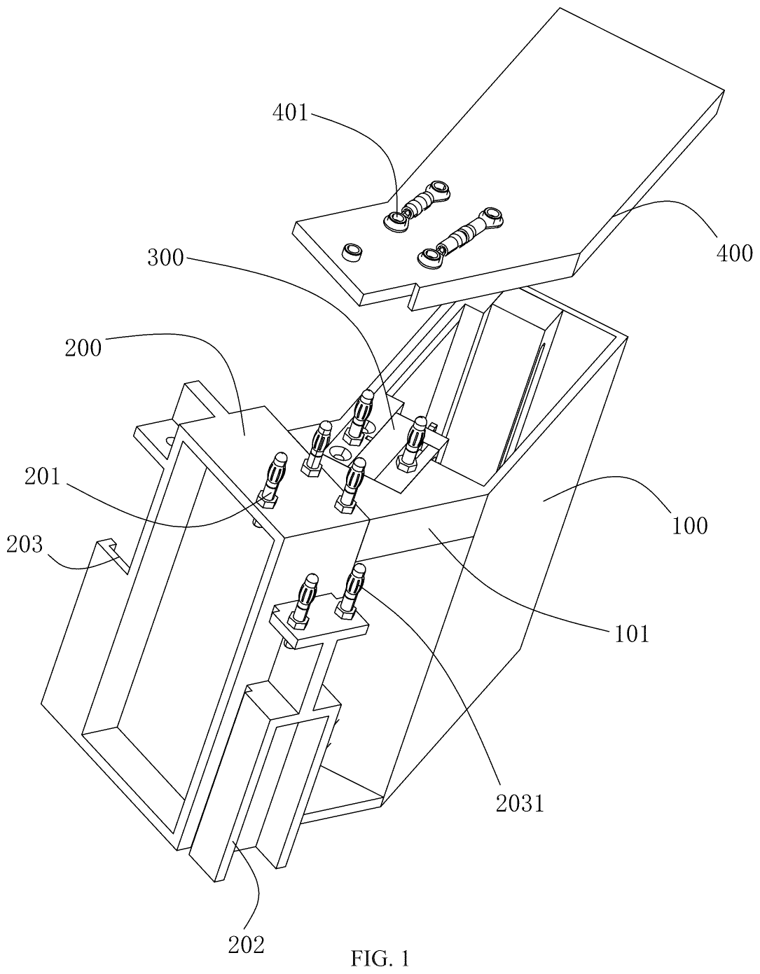

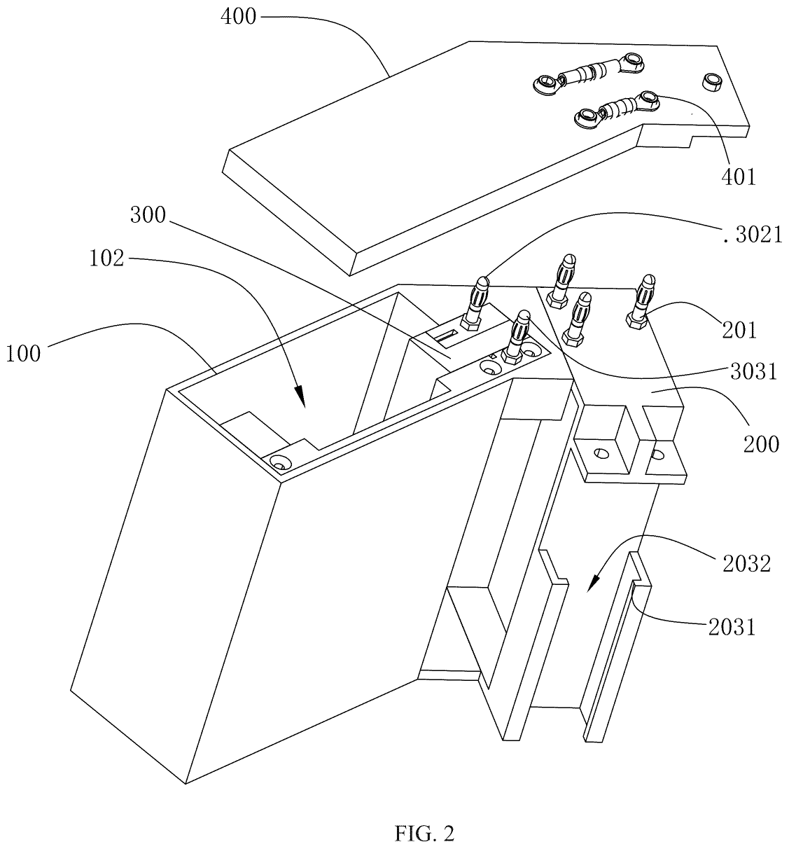

As shown in FIGS. 1 and 2, the present disclosure provides an electrophoresis device, mainly including electrophoresis tank body 100, electrode holder 300, gel plate 500, and connecting frame 200.

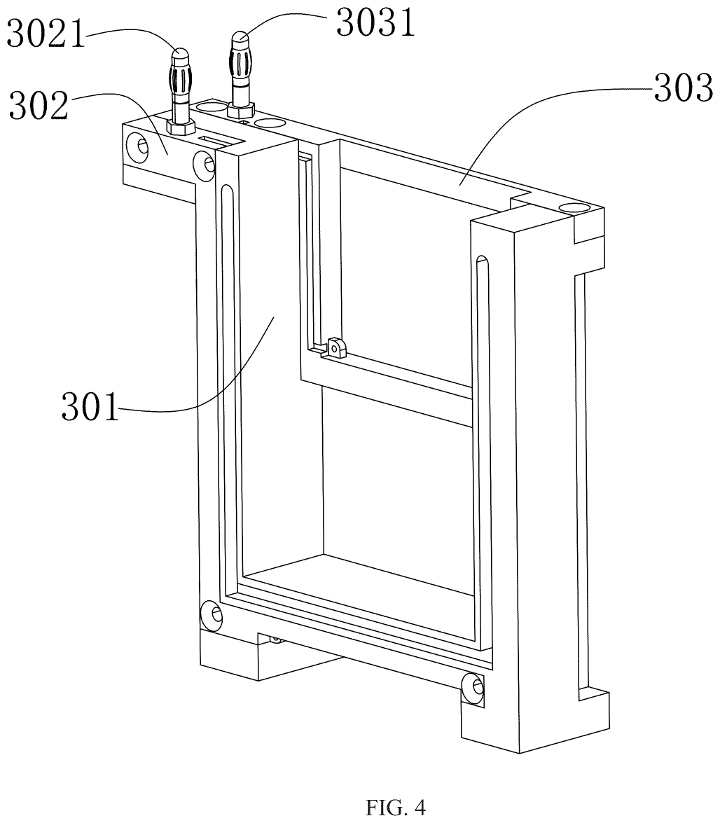

The electrophoresis tank body 100 is provided with first chamber 102 and first opening configured to connect the first chamber 102 to the outside. As shown in FIG. 2, the first opening is provided upward. The electrode holder 300 is detachably provided in the first chamber 102 of the electrophoresis tank body 100. The electrode holder 300 is provided with second chamber 3016, a second opening configured to connect the second chamber 3016 to the outside, and a first experimental port that is connected to the second chamber. As shown in FIG. 4, the second opening is provided upward. As shown in FIG. 4, the first experimental port is provided at a side of the electrode holder 300.

The electrode holder 300 is a detachable structure. The electrode holder 300 is provided with a positive electrode wire and a negative electrode wire. The positive electrode wire and the negative electrode wire are respectively connected to a positive electrode and a negative electrode of a power source to form a uniform electric field between the positive electrode wire and the negative electrode wire. The positive electrode wire is located outside the second chamber 3016, and the negative electrode wire is partially located inside the second chamber 3016. In this embodiment, the positive electrode wire and the negative electrode wire are platinum wires. Alternatively, the positive electrode wire and the negative electrode wire can also be made of other conductive metals, such as silver or copper.

The gel plate 500 is coated with a precast gel. The gel plate 500 is detachably provided on the electrode holder 300, and the gel plate 500 can seal the first experimental port. During a gel running experiment, the first chamber 102 and the second chamber 3016 are filled with a buffer solution. The gel plate 500 seals the first experimental port, such that the positive electrode wire located in the first chamber 102 and the negative electrode wire located inside the second chamber 3016 are insulated to form the electric field required for the experiment.

The connecting frame 200 is provided at a side of the electrophoresis tank body 100. The connecting frame 200 is mainly configured to splice two adjacent electrophoresis tank bodies 100. The connecting frame 200 is provided with first wiring terminals 201. In this embodiment, there are three first wiring terminals 201. The first wiring terminals 201 are respectively electrically connected to the positive electrode wire and the negative electrode wire to achieve a series or parallel connection of the circuits between the spliced two adjacent electrophoresis tank bodies 100, thereby providing a required constant-current or constant-voltage experimental mode.

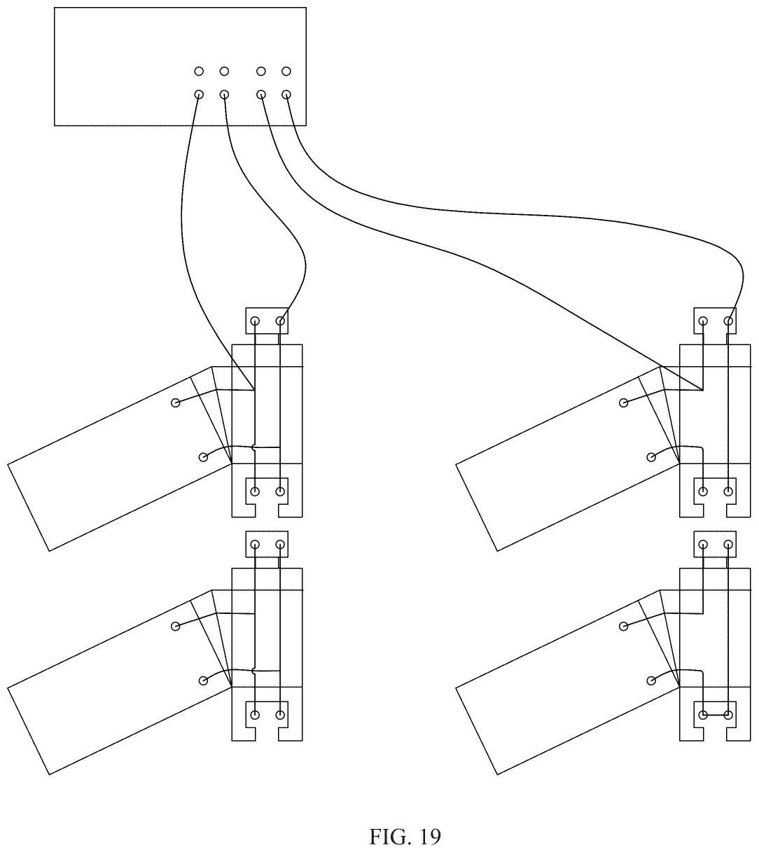

In the present application, the electrode holder 300 is a dividable structure. Compared to traditional integrated electrode holder 300, when a single component of the electrode holder 300 in the present application is damaged, only the damaged component of the electrode holder 300 needs to be replaced, without the need for an overall replacement, saving costs and making the operation simple without a complex procedure. The connecting frame 200 realizes the splicing between the electrophoresis tank bodies 100. The connecting frame 200 is provided with the first wiring terminals 201 that are respectively electrically connected to the positive electrode wire and the negative electrode wire to provide a constant-current series connection or constant-voltage parallel connection between the circuits according to experimental requirements, as shown in FIG. 19. The design can realize a gel running experiment through a plurality of gel plates 500 according to experimental requirements, saving experimental time and improving experimental efficiency.

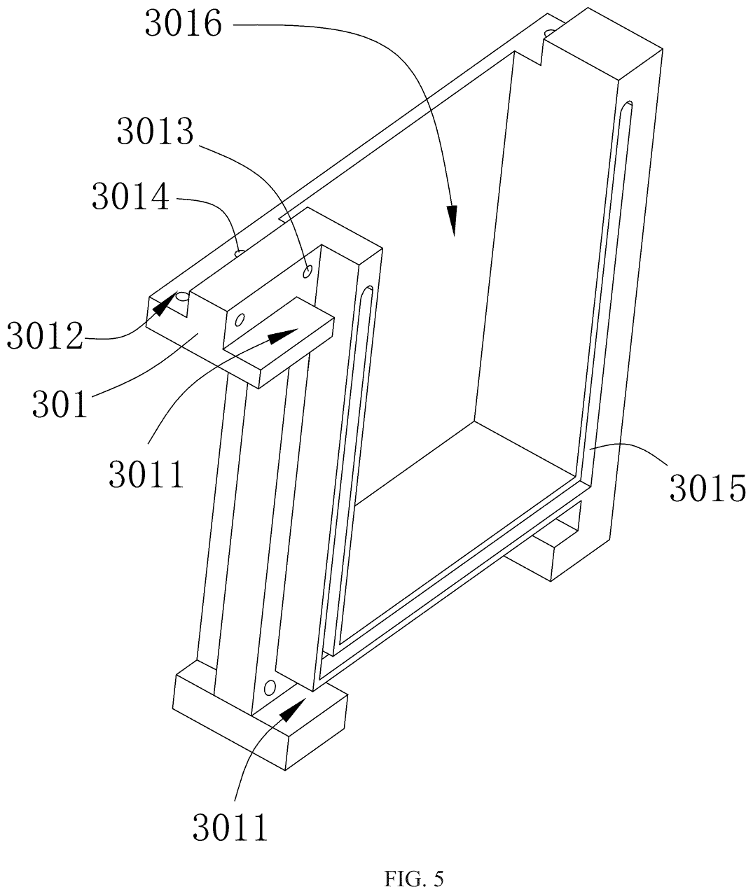

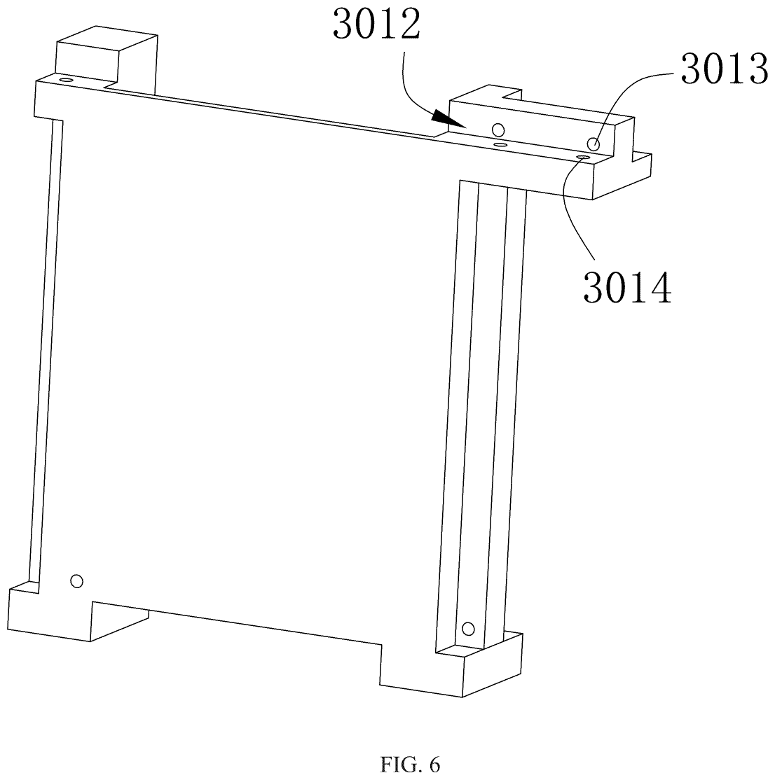

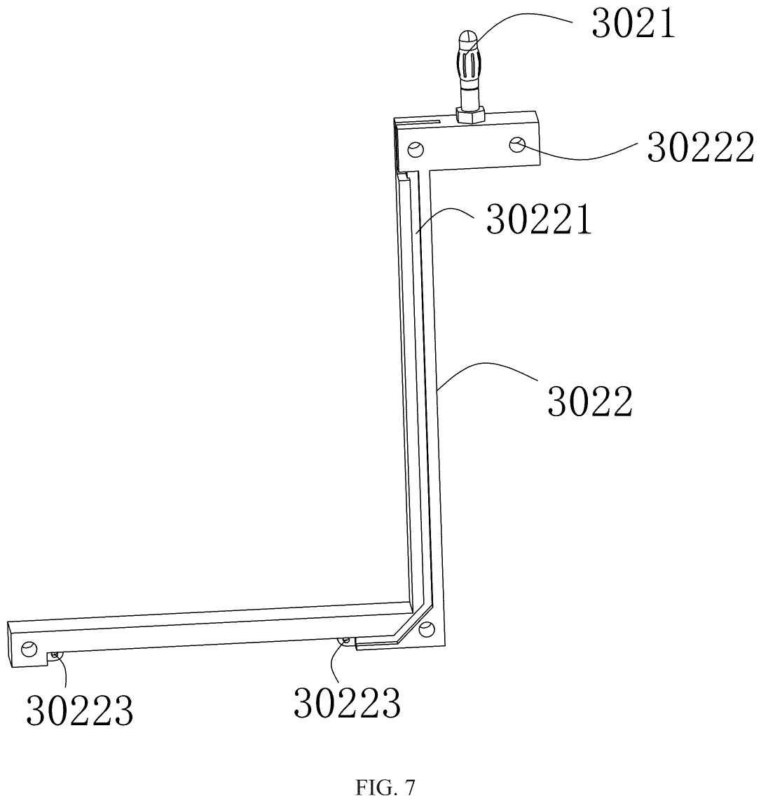

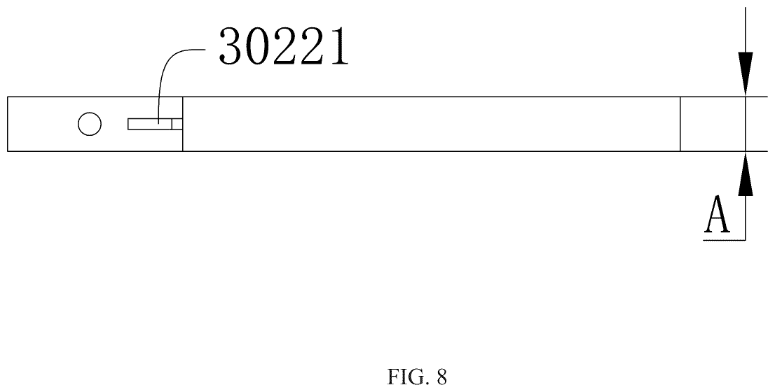

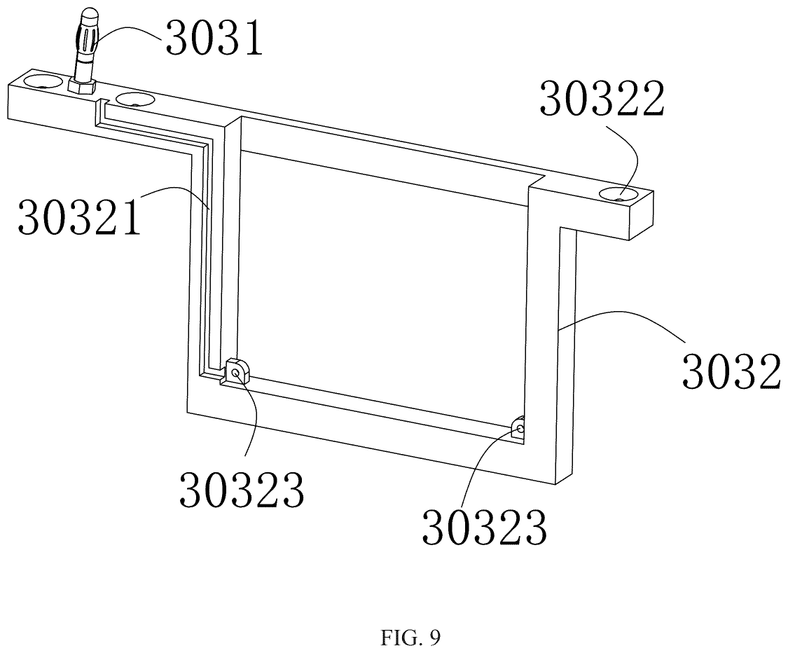

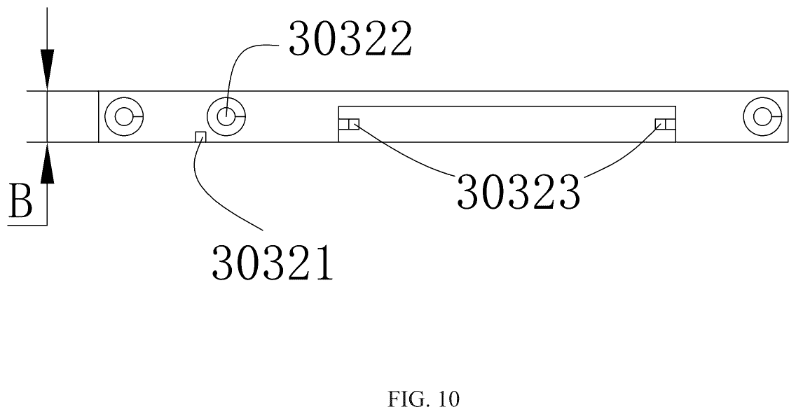

In an embodiment, as shown in FIGS. 4 to 10, the electrode holder 300 is divided into support frame body 301, positive electrode assembly 302, and negative electrode assembly 303. The positive electrode assembly 302 and the negative electrode assembly 303 are detachably provided on the support frame body 301. Specifically, as shown in FIG. 5, the support frame body 301 is provided with first mounting groove 3011 and second mounting groove 3012. The first mounting groove 3011 is adapted to positive electrode holder 3022 of the positive electrode assembly 302, and the second mounting groove 3012 is adapted to negative electrode holder 3032 of the negative electrode assembly 303. The positive electrode holder 3022 is detachably provided in the first mounting groove 3011, and the negative electrode holder 3032 is detachably provided in the second mounting groove 3012. It should be noted that when the positive electrode holder 3022 and the negative electrode holder 3032 are respectively provided in the first mounting groove 3011 and the second mounting groove 3012, the positive electrode holder 3022 will not protrude from a side of the support frame body 301, and the negative electrode holder 3032 will not protrude from a side of the support frame body 301. That is, as shown in FIGS. 8 and 10, thickness A of the positive electrode holder 3022 is less than or equal to a depth of the first mounting groove 3011, and thickness B of the negative electrode holder 3032 is less than or equal to a depth of the second mounting groove 3012. Further, the positive electrode assembly 302 includes the positive electrode holder 3022 and positive electrode wiring terminal 3021, and the positive electrode wiring terminal 3021 is provided on the positive electrode holder 3022. The negative electrode assembly 303 includes the negative electrode holder 3032 and negative electrode wiring terminal 3031. The negative electrode wiring terminal 3031 is provided on the negative electrode holder 3032. The positive electrode wire is provided on the positive electrode holder 3022, and one end of the positive electrode wire is electrically connected to the positive electrode wiring terminal 3021. The negative electrode wire is provided on the negative electrode holder 3032, and one end of the negative electrode wire is electrically connected to the negative electrode wiring terminal 3031. Specifically, the support frame body 100 is provided with first threaded hole 3013, and the positive electrode holder 3022 is provided with second through hole 30222. A first screw is passed through the second through hole 30222 and inserted into the first threaded hole 3013 to fix the positive electrode holder 3022. Similarly, the support frame body 301 is provided with second threaded hole 3014, and the negative electrode holder 3032 is provided with third through hole 30322. A second screw is passed through the third through hole 30322 and inserted into the second threaded hole 3014 to fix the negative electrode holder 3032.

In an embodiment, the positive electrode holder 3022 is provided with first wiring slot 30221, and the positive electrode wire includes a first insulating section and a first exposed section. The first insulating section of the positive electrode wire is provided in the first wiring slot 30221, and the first exposed section of the positive electrode wire is exposed outside the positive electrode holder 3022 and located outside the second chamber 3016. Further, similarly, the negative electrode holder 3032 is provided with second wiring slot 30321, and the negative electrode wire includes a second insulating section and a second exposed section. The second insulating section of the negative electrode wire is provided in the second wiring slot 30321, and the second exposed section of the negative electrode wire is exposed outside the negative electrode holder 3032 and located inside the second chamber 3016. It should be noted that, in order to facilitate the formation of the uniform electric field, the second exposed section of the negative electrode wire and the first exposed section of the positive electrode wire are in a position correspondence and parallel to each other. Further, the positive electrode wire and the positive electrode holder 3022 can also be integrated. That is, the first insulating section of the positive electrode wire is integrated with the positive electrode holder 3022, and the first exposed section of the positive electrode wire is located outside the positive electrode holder 3022. Similarly, the negative electrode holder 3032 and the negative electrode wire can also be integrated. That is, the second insulating section of the negative electrode wire is integrated with the negative electrode holder 3032, and the second exposed section of the negative electrode wire is located outside the negative electrode holder 3032. Further, due to the high cost of the platinum wires, the first insulating section of the positive electrode wire and the second insulating section of the negative electrode wire can be made of copper or silver wires, and the first exposed section of the positive electrode wire and the second exposed section of the negative electrode wire can be made of platinum wires. The design can achieve similar experimental effects.

In an embodiment, to facilitate the fixation of the first exposed section of the positive electrode wire and the second exposed section of the negative electrode wire, the positive electrode holder 3022 is provided with first fixing structure 30223 to fix the first exposed section of the positive electrode wire, and the negative electrode holder 3032 is provided with second fixing structure 30323 to fix the second exposed section of the negative electrode wire. In this embodiment, the first fixing structure 30223 and the second fixing structure 30323 are fixing holes. Alternatively, the first fixing structure 30223 and the second fixing structure 30323 can also be fixing posts.

In an embodiment, the design shown in FIG. 4 can achieve better experimental results. During the experiment, heat is generated and transfers upward from a bottom of the electrode holder 300. When the first exposed section of the negative electrode wire is located at the bottom of the electrode holder 300, at the beginning of the experiment, the temperature is normal and the gel running experiment is normal. However, as the time goes by, the heat at the lower part increases. As the heat transfer rises, due to temperature differences, the gel running effect will present a trapezoidal structure, resulting in poor gel running effect. When the second exposed section of the negative electrode wire is located at a feed slot, since it is close to the sample source and there is little buffer solution, the gel running experiment results are poor. Comparisons of a plurality of experimental indicate that when a distance between the second exposed section of the negative electrode wire and a bottom wall of the electrode holder 300 is one-half of a depth of the second chamber 3016 of the electrode holder 300, the best gel running effect can be achieved.

In an embodiment, the connecting frame 200 is integrated with the electrophoresis tank body 100. Alternatively, the connecting frame 200 is detachably connected to the electrophoresis tank body 100.

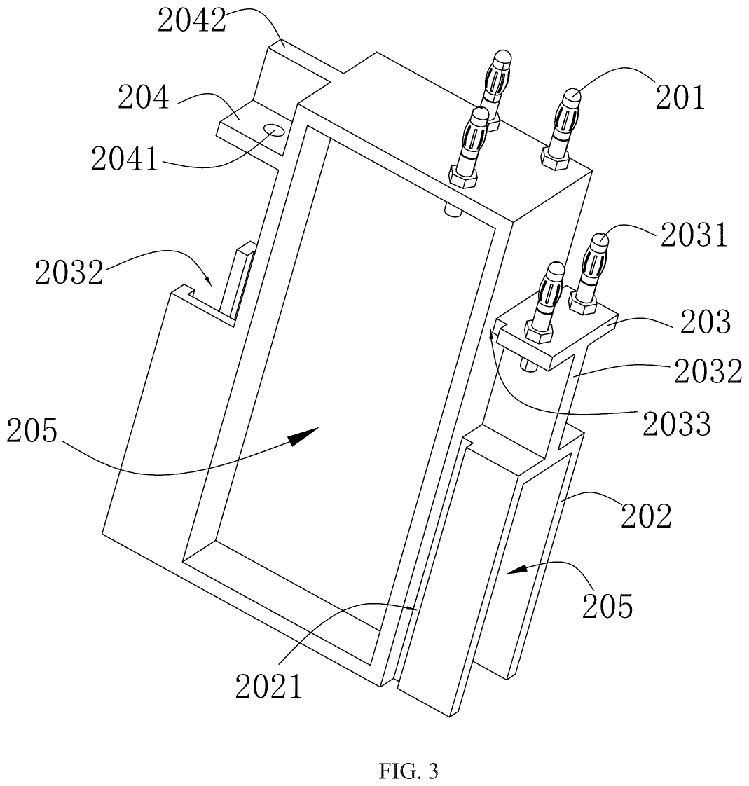

Further, as shown in FIG. 3, the connecting frame 200 includes clamping boss 202 and clamping groove 2032 adapted to the clamping boss. When two adjacent electrophoresis tank bodies 100 are connected, the clamping boss 202 on the connecting frame 200 of first electrophoresis tank body 100 is clamped into the clamping groove 2032 on the connecting frame 200 of second electrophoresis tank body 100. Alternatively, the clamping groove 2032 on the connecting frame 200 of the first electrophoresis tank body 100 is clamped onto the clamping boss 202 on the connecting frame 200 of the second electrophoresis tank body 100.

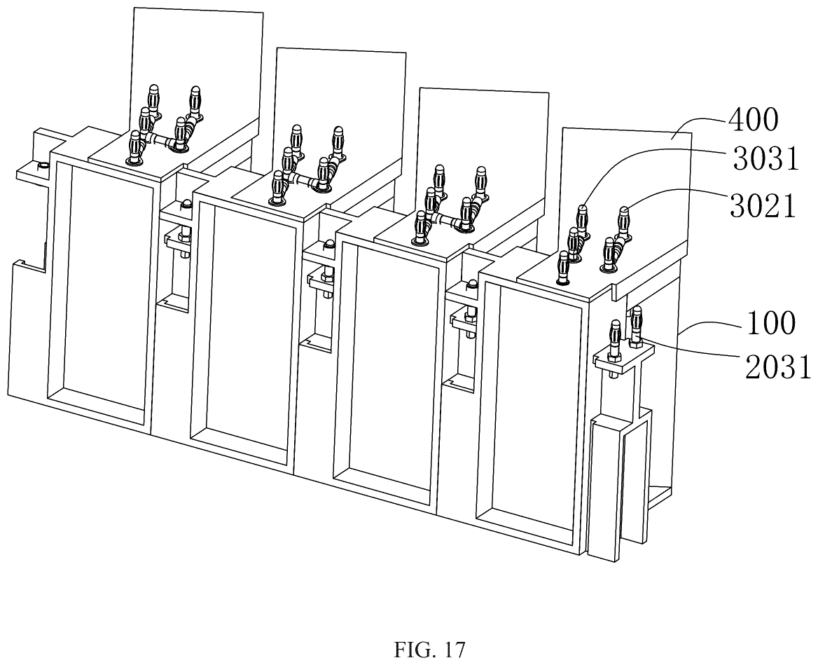

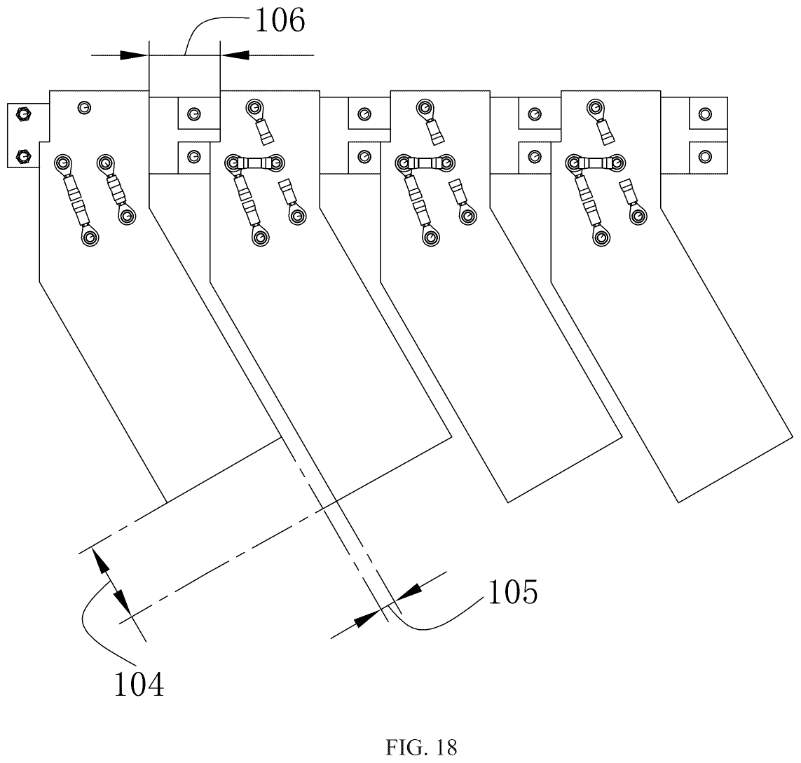

In an embodiment, as shown in FIGS. 17 and 18, in order to facilitate the real-time observation of the experimental process, the electrophoresis tank body 100 is inclined such that the two adjacent electrophoresis tank bodies 100 are misaligned. As shown in FIG. 18, visible third spacing 104 is formed between the first electrophoresis tank body 100 and the second electrophoresis tank body 100, allowing real-time observation of the gel running experiment of the gel plate 500 on the electrode holder 300. Further, in order to reduce the volume of the electrophoresis tank body 100, due to the need to misalign the two adjacent electrophoresis tank bodies 100, connecting plate 101 is provided between the electrophoresis tank body 100 and the connecting frame 200. The connecting plate 101 is at a preset angle to the electrophoresis tank body 100 such that the electrophoresis tank body 100 is inclined relative to the connecting frame 200. As shown in FIG. 18, first spacing 106 is provided between the two adjacent connecting frames 200. According to the first spacing 106, second spacing 105 is formed between the two adjacent electrophoresis tank bodies 100 to avoid mutual obstruction or mutual heat influence, and facilitate the assembly of the two adjacent electrophoresis tank bodies 100. Optionally, the second spacing 105 can also be zero, and the first spacing 106 depends on the size of a first mounting plate.

In an embodiment, in order to prevent the separation between the two adjacent electrophoresis tank bodies 100, a first boss 2031 is provided on each of two side plates that form the clamping groove 2032. The clamping boss 202 is provided with a first slot 2021 that is adapted to the first boss 2031. When the two adjacent electrophoresis tank bodies 100 are spliced together, the first boss 2031 of the first electrophoresis tank body 100 is clamped into the first slot 2021 of the second electrophoresis tank body 100, further reinforcing the entire device.

Further, in order to make the splicing structure of the two adjacent electrophoresis tank bodies 100 more compact, the first slot 2021 is arranged along a side of the connecting frame 200. When the first boss 2031 on the connecting frame 200 of the first electrophoresis tank body 100 is clamped into the first slot 2021 on the connecting frame 200 of the second electrophoresis tank body 100, the clamping boss 202 on the connecting frame 200 of the second electrophoresis tank body 100 abuts against a side wall of the connecting frame 200 of the first electrophoresis tank body 100. In this way, the first spacing 106 shown in FIG. 18 is formed.

In an embodiment, in order to achieve rapid connection of the circuits between the two adjacent electrophoresis tank bodies 100, the connecting frame 200 is provided with the first mounting plate 203 at a side of the clamping boss 202. The first mounting plate 203 is provided with second wiring terminals 2031 that are electrically connected to the first wiring terminals 201 and first avoidance groove 2033 that is in a position correspondence with the first slot 2021. When the two adjacent electrophoresis tank bodies 100 are connected, the first mounting plate 203 on the connecting frame 200 of the second electrophoresis tank body 100 abuts against the connecting frame 200 on the first electrophoresis tank body 100. In this embodiment, there are two second wiring terminals 2031, which are respectively connected to the positive electrode wire and the negative electrode wire of the power source. Further, the connecting frame 200 is provided with first support plate 204 at a side of the clamping groove 2032. The first support plate 204 is provided with first through holes 2041 adapted to the second wiring terminals 2031. When the two adjacent electrophoresis tank bodies 100 are connected, one end of the second wiring terminal 2031 on the first mounting plate 203 of the second electrophoresis tank body 100 passes through the first through hole 2041 on the first support plate 204 of the first electrophoresis tank body 100, and the first support plate 204 abuts against the side wall of the adjacent connecting frame 200. The design further ensures support and positioning of the two adjacent connecting frames 200, making their splicing and connection more stable. Further, in order to reinforce the structure of the first mounting plate 203 and the first support plate 204, the first mounting plate 203 is provided with first reinforcing rib 2032, and the first support plate 204 is provided with second reinforcing rib 2042. Further, in order to reduce the overall weight of the connecting frame 200, the connecting frame 200 is provided with a plurality of hollow structures 205.

In an embodiment, the electrophoresis device further includes first tank cover 400. The first tank cover 400 is detachably provided on the first opening of the electrophoresis tank body 100. The first tank cover 400 is provided with a plurality of terminal caps 401. A pre-connection circuit is provided between the plurality of terminal caps 401. The first wiring terminals 201, the positive electrode wiring terminal 3021, and the negative electrode wiring terminal 3031 are inserted into the plurality of terminal caps 401 in a one-to-one correspondence to achieve the series or parallel connection of the circuits between the two adjacent electrophoresis tank bodies 100, thereby achieving the rapid connection of the circuits between the two adjacent electrophoresis tank bodies 100. Further, the first tank covers 400 are provided in two different colors. The first tank covers 400 in the two different colors are respectively configured for different circuit pre-settings. For example, first tank covers in black are configured to set up a series circuit, and first tank covers in red are configured to set up a parallel circuit. Through the different colors, operators can quickly identify whether the mounting of the first tank cover 400 is correct and whether the circuit used in the batch of experiment is a series or parallel circuit, without the need to confirm the specific connection method of the circuit of the first tank cover 400.

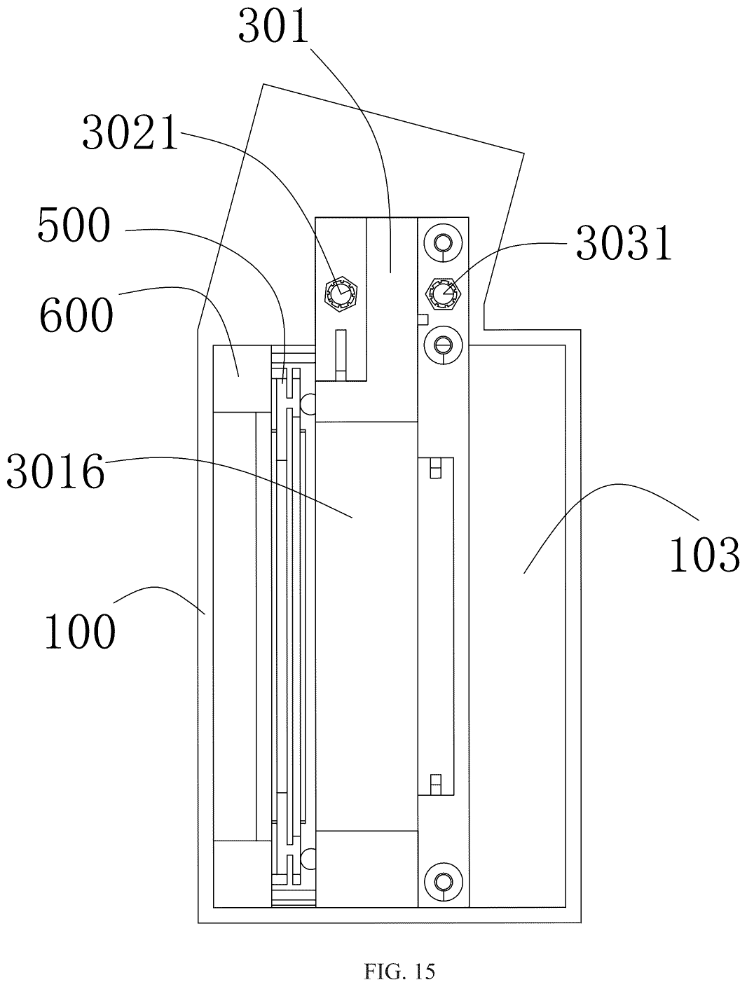

In an embodiment, to reduce the difficulty of sealing the electrode holder 300, the electrophoresis tank body 100 adopts a single gel tank structure. Specifically, the first experimental port of the electrode holder 300 is provided at a single side, and there is only one first experimental port. A preset spacing is formed between the electrode holder 300 and the electrophoresis tank body 100, and the gel plate 500 is detachably provided within the preset spacing. As another variation of this embodiment, as shown in FIG. 15, cooling cavity 103 can also be provided to cool the entire device, avoiding the impact of an excessive temperature on the electrophoresis experiment.

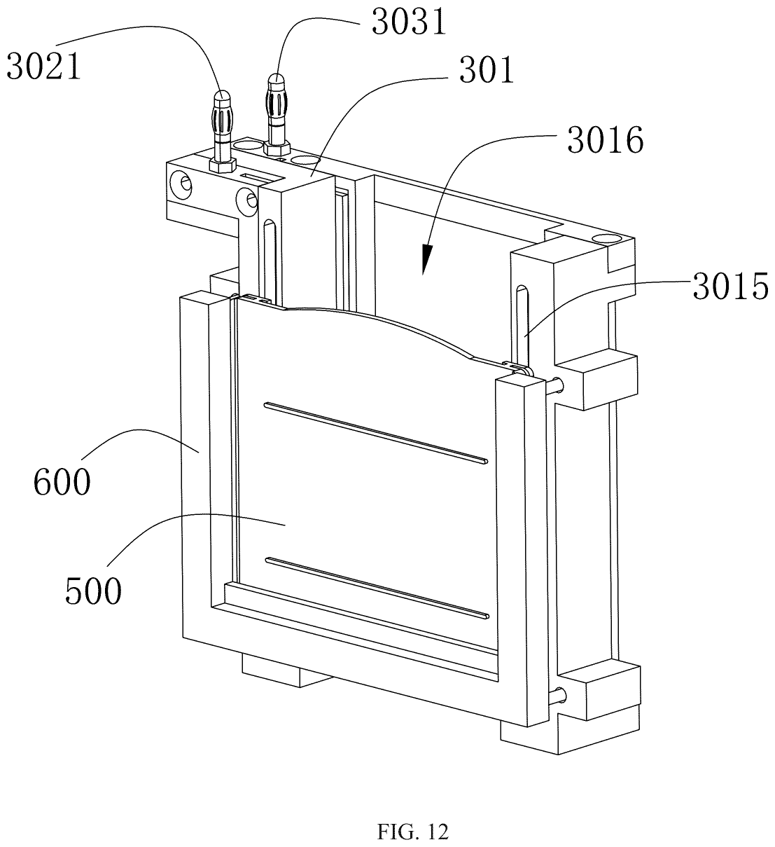

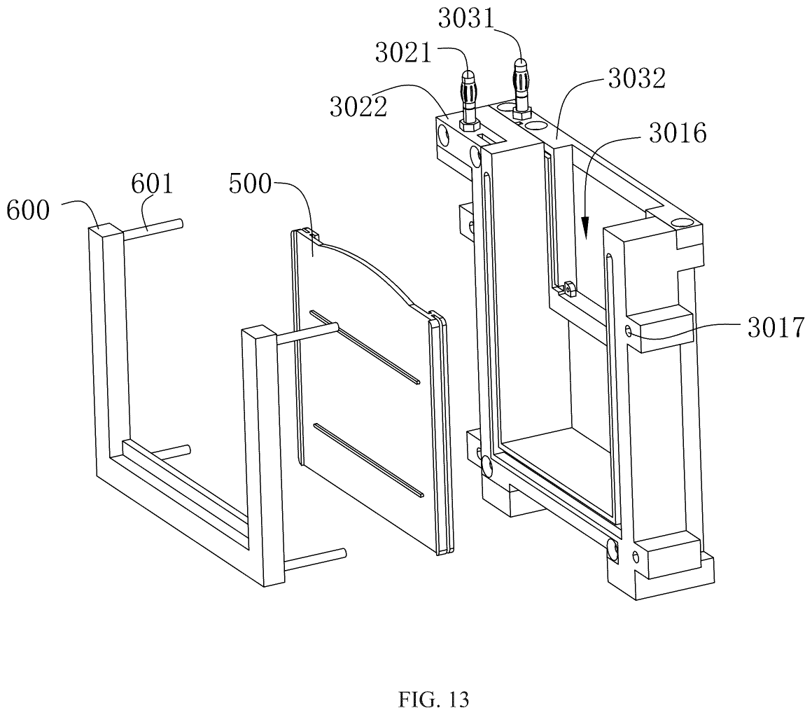

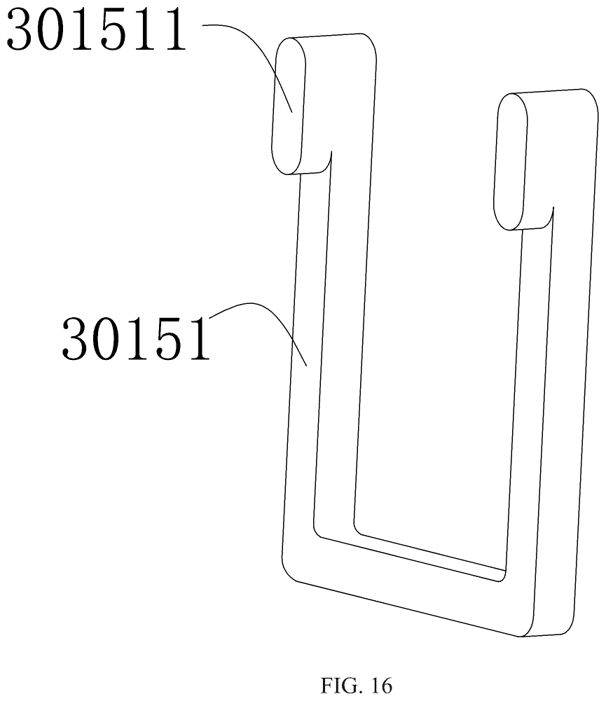

Further, as shown in FIGS. 12, 13, and 16, first sealing groove 3015 is provided at a side of the first experimental port of the electrode holder 300. First sealing strip 30151 is provided inside the first sealing groove 3015. The first sealing strip 30151 partially protrudes from the first sealing groove 3015. When the gel plate 500 is provided within the preset spacing, the first sealing strip 30151 is in a compressed state to seal the first experimental port, allowing the first chamber 102 and the second chamber 3016 to be insulated.

Further, the first sealing strip 30151 is detachably provided in the first sealing groove 3015. A side of the first sealing strip 30151 away from a bottom wall of the electrophoresis tank body 100 is provided with clamping step 301511. The commonly used gel plate 500 on the market is suitable for precast or handcast gels of different sizes, including 80 mm*100 mm and 100 mm*100 mm. When the gel plate 500 is applied to precast or handcast gels of different sizes, the height of the feed slot varies. That is, a step structure with different heights will be formed on the gel plate 500. In order to make the electrophoresis device adapted to the gel plate 500 suitable for precast or handcast gels of two different sizes, the first sealing strip 30151 is detachably provided in the first sealing groove 3015, and the first sealing strip 30151 is provided with the step structures 301511. When the gel plate 500 suitable for precast or handcast gels of different sizes is used, only the corresponding first sealing strip 30151 needs to be replaced. The first sealing strip 30151 is provided with two step structures 301511 of different lengths, which can accurately seal the gel plate 500 suitable for precast or hand cast gels of different sizes, improving the adaptability of the electrophoresis device.

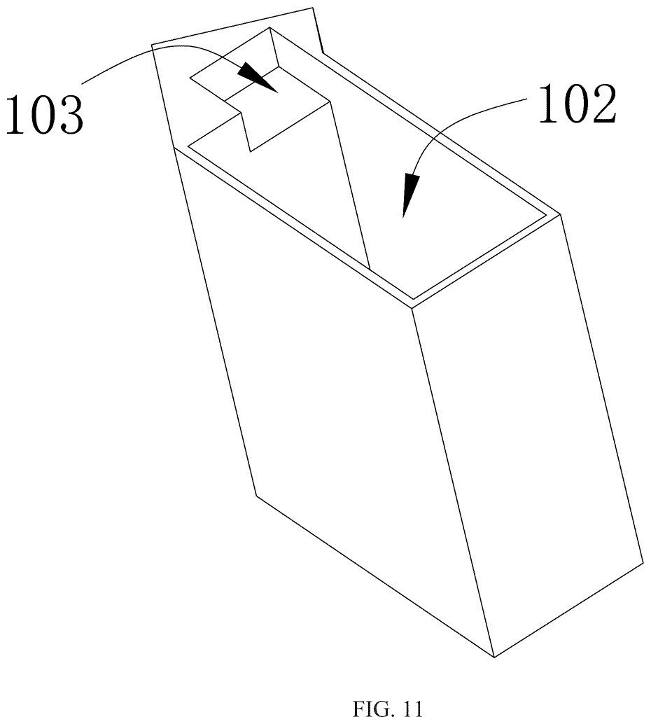

In an embodiment, in order to stably fix the electrode holder 300 in the first chamber 102 of the electrophoresis tank body 100, as shown in FIG. 11, the electrophoresis tank body 100 is provided with first clamping groove 103, and the electrode holder 300 is provided with a first clamping boss. When the first clamping boss of the electrode holder 300 is clamped into the first clamping groove 103 of the electrophoresis tank body 100, a side wall of the electrode holder 300 abuts against a side wall of the electrophoresis tank body 100. Specifically, a side wall of the electrode holder 300 without the gel plate 500 abuts against an inner wall of the electrophoresis tank body 100, such that the electrode holder 300 is stably provided in the electrophoresis tank body 100.

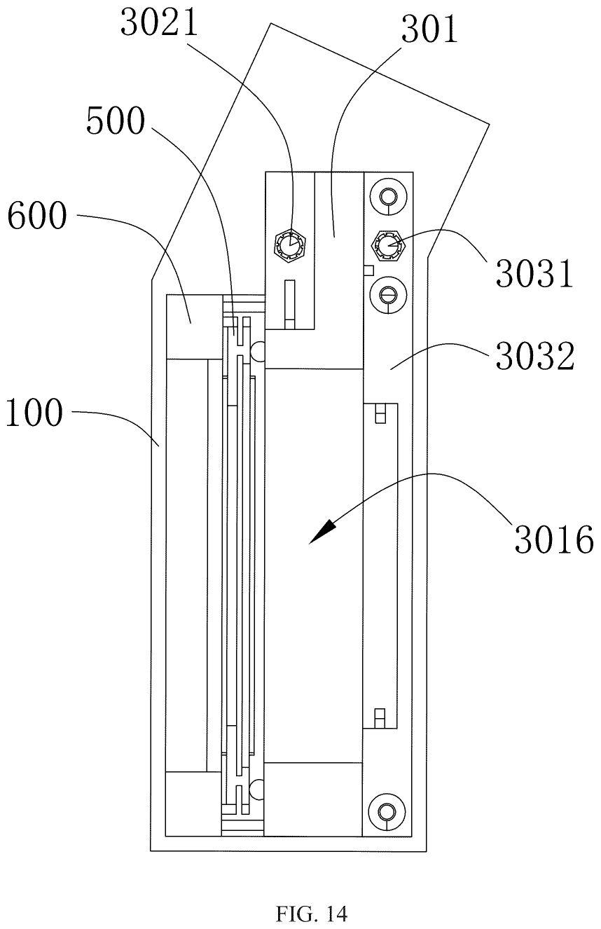

In an embodiment, as shown in FIGS. 14 and 15, to further support the gel plate 500, pressure plate 600 is provided between the electrophoresis tank body 100 and the gel plate 500. One side of the pressure plate 600 abuts against the gel plate 500, and the other side of the pressure plate 600 abuts against the inner wall of the electrophoresis tank body 100, such that the pressure plate 600 supports the gel plate 500. During mounting, the pressure plate 600 drives the overall translation of the gel plate 500. Compared to the traditional hinged rotation method of driving the pressure plate 600 to squeeze and seal, the overall translation method improves the sealing effect of the gel plate 500 on the first experimental port.

Further, in order to reduce the volume of the pressure plate 600, an outline structure of the pressure plate 600 is identical to a structure of the first sealing groove 3015, and the pressure plate 600 covers the first sealing groove 3015. Specifically, the first sealing groove 3015 is a U-shaped structure, so the pressure plate 600 is also a U-shaped structure. It is only necessary for an edge of the pressure plate 600 to cover an edge of the first sealing strip 30151. The design ensures the sealing effect, reduces the volume of the pressure plate 600, and facilitates the operator to squeeze and seal the gel plate 500.

Further, to avoid displacement in the position of the pressure plate 600, the pressure plate 600 is provided with guide posts 601, and the electrode holder 300 is provided with adapted guide holes 3017. Alternatively, the pressure plate 600 is provided with guide holes 3017, and the electrode holder 300 is provided with guide posts 601. The guide posts 601 are respectively inserted into the guide holes 3017. The guide posts 601 are movable axially along the guide holes 3017 to drive the gel plate 500 to translate in its entirety for sealing and avoid the displacement in the position of the pressure plate 600.

In an embodiment, as shown in FIG. 18, the electrophoresis tank bodies 100 are arranged linearly. The actual number of the electrophoresis tank bodies 100 is preset according to experimental requirements and is not limited by the present disclosure. Therefore, three, four, or five electrophoresis tank bodies can be provided.

The above described are merely preferred implementations of the present disclosure. It should be noted that those of ordinary skill in the art may further make improvements and modifications to the present disclosure without departing from the principle of the present disclosure. However, these improvements and modifications should be deemed as falling within the protection scope of the present disclosure.

1. An electrophoresis device, comprising:
an electrophoresis tank body, provided with a first chamber and a first opening configured to connect the first chamber to an outside;
an electrode holder, located in the first chamber of the electrophoresis tank body, and provided with a second chamber, a second opening connected to the second chamber, and a first experimental port connected to the second chamber, wherein the electrode holder is further provided with a positive electrode wire and a negative electrode wire, and the positive electrode wire and the negative electrode wire are configured to form a uniform electric field; and the positive electrode wire is partially located outside the second chamber, and the negative electrode wire is partially located inside the second chamber;
a gel plate, coated with a precast gel, and detachably provided on the electrode holder, wherein the gel plate is configured to seal the first experimental port of the electrode holder, such that the first chamber and the second chamber are independent of each other; and
a connecting frame, provided at a side of the electrophoresis tank body, and configured to connect two adjacent electrophoresis tank bodies, wherein the connecting frame is provided with a plurality of first wiring terminals; and the plurality of first wiring terminals are respectively electrically connected to the positive electrode wire and the negative electrode wire, wherein a series or parallel connection of circuits between the two adjacent electrophoresis tank bodies is allowed.

2. The electrophoresis device according to claim 1, wherein the electrode holder comprises a support frame body, a positive electrode assembly, and a negative electrode assembly; the support frame body is provided with a first mounting groove adapted to the positive electrode assembly and a second mounting groove adapted to the negative electrode assembly; and the positive electrode assembly is detachably provided in the first mounting groove of the support frame body, and the negative electrode assembly is detachably provided in the second mounting groove of the support frame body.

3. The electrophoresis device according to claim 2, wherein the positive electrode assembly comprises a positive electrode holder and a positive electrode wiring terminal provided on the positive electrode holder; the negative electrode assembly comprises a negative electrode holder and a negative electrode wiring terminal provided on the negative electrode holder; the positive electrode wire is provided on the positive electrode holder and electrically connected to the positive electrode wiring terminal; and the negative electrode wire is provided on the negative electrode holder and electrically connected to the negative electrode wiring terminal.

4. The electrophoresis device according to claim 3, wherein the positive electrode holder is provided with a first wiring slot; the positive electrode wire comprises a first insulating section and a first exposed section; and the first insulating section of the positive electrode wire is located in the first wiring slot, and the first exposed section of the positive electrode wire is fixed to the positive electrode holder.

5. The electrophoresis device according to claim 4, wherein the negative electrode holder is provided with a second wiring slot; the negative electrode wire comprises a second insulating section and a second exposed section; the second insulating section of the negative electrode wire is located in the second wiring slot, and the second exposed section of the negative electrode wire is fixed to the negative electrode holder; and the second exposed section of the negative electrode wire and the first exposed section of the positive electrode wire are in a position correspondence and parallel to each other.

6. The electrophoresis device according to claim 5, wherein the positive electrode holder is provided with a first fixing structure, and the first exposed section of the positive electrode wire is fixed to the positive electrode holder through the first fixing structure; and the negative electrode holder is provided with a second fixing structure, and the second exposed section of the negative electrode wire is fixed to the negative electrode holder through the second fixing structure.

7. The electrophoresis device according to claim 5, wherein a distance between the second exposed section of the negative electrode wire and a bottom wall of the electrode holder is one-half of a depth of the second chamber of the electrode holder.

8. The electrophoresis device according to claim 3, wherein the positive electrode wire and the positive electrode holder are integrated, and the negative electrode wire and the negative electrode holder are integrated.

9. The electrophoresis device according to claim 3, wherein the connecting frame and the electrophoresis tank body are integrated or detachably connected.

10. The electrophoresis device according to claim 9, wherein the connecting frame comprises a clamping boss and a clamping groove adapted to the clamping boss; when the two adjacent electrophoresis tank bodies are connected, the clamping boss on the connecting frame of a first electrophoresis tank body of the two adjacent electrophoresis tank bodies is clamped into the clamping groove on the connecting frame of a second electrophoresis tank body of the two adjacent electrophoresis tank bodies; and alternatively, the clamping groove on the connecting frame of the first electrophoresis tank body is clamped onto the clamping boss on the connecting frame of the second electrophoresis tank body.

11. The electrophoresis device according to claim 10, wherein the electrophoresis tank body is inclined to allow the two adjacent electrophoresis tank bodies to be misaligned.

12. The electrophoresis device according to claim 11, wherein a connecting plate is provided between the connecting frame and the electrophoresis tank body; and the connecting plate is at a preset angle to the electrophoresis tank body such that the electrophoresis tank body is inclined relative to the connecting frame.

13. The electrophoresis device according to claim 10, wherein the clamping groove is provided with a first boss, and the clamping boss is provided with a first slot adapted to the first boss; and when the two adjacent electrophoresis tank bodies are connected, the first boss of the first electrophoresis tank body is clamped into the first slot of the second electrophoresis tank body.

14. The electrophoresis device according to claim 13, wherein the first slot is arranged along a side of the connecting frame; and when the first boss on the connecting frame of the first electrophoresis tank body is clamped into the first slot on the connecting frame of the second electrophoresis tank body, the clamping boss on the connecting frame of the second electrophoresis tank body abuts against a side wall of the connecting frame of the first electrophoresis tank body.

15. The electrophoresis device according to claim 13, wherein the connecting frame is provided with a first mounting plate at a side of the clamping boss; the first mounting plate is provided with a plurality of second wiring terminals and a first avoidance groove, wherein the plurality of second wiring terminals are correspondingly electrically connected to the plurality of first wiring terminals, and the first avoidance groove is in a position correspondence with the first slot; and when the two adjacent electrophoresis tank bodies are connected, the first mounting plate on the connecting frame of the second electrophoresis tank body abuts against the connecting frame of the first electrophoresis tank body.

16. The electrophoresis device according to claim 15, wherein the connecting frame is provided with a first support plate at a side of the clamping groove; the first support plate is provided with a plurality of first through holes adapted to the plurality of second wiring terminals; and when the two adjacent electrophoresis tank bodies are connected, ends of the plurality of second wiring terminals on the first mounting plate of the second electrophoresis tank body respectively pass through the plurality of first through holes on the first support plate of the first electrophoresis tank body, and the first support plate abuts against a side wall of an adjacent connecting frame.

17. The electrophoresis device according to claim 15, further comprising a first tank cover, wherein the first tank cover is detachably located on the first opening of the electrophoresis tank body, and the first tank cover is provided with a plurality of terminal caps; a pre-connection circuit is provided between the plurality of terminal caps; and the plurality of first wiring terminals, the positive electrode wiring terminal, and the negative electrode wiring terminal are inserted into the plurality of terminal caps in a one-to-one correspondence to achieve the series or parallel connection of the circuits between the two adjacent electrophoresis tank bodies.

18. The electrophoresis device according to claim 17, wherein first tank covers are provided in two different colors; and the first tank covers in the two different colors are correspondingly provided with different pre-connection circuits.

19. The electrophoresis device according to claim 1, wherein the electrophoresis tank body is a single gel tank structure; the first experimental port of the electrode holder is provided at a single side; a preset spacing is formed between the electrode holder and the electrophoresis tank body; and the gel plate is detachably provided within the preset spacing.

20. The electrophoresis device according to claim 19, wherein a first sealing groove is provided at a side of the first experimental port of the electrode holder; a first sealing strip is provided inside the first sealing groove; the first sealing strip partially protrudes from the first sealing groove; and when the gel plate is provided within the preset spacing, the first sealing strip is in a compressed state.

21. The electrophoresis device according to claim 20, wherein the first sealing strip is detachably provided in the first sealing groove; and a side of the first sealing strip away from a bottom wall of the electrophoresis tank body is provided with a clamping step.

22. The electrophoresis device according to claim 20, wherein the electrophoresis tank body is provided with a first clamping groove, and the electrode holder is provided with a first clamping boss; and when the first clamping boss of the electrode holder is clamped into the first clamping groove of the electrophoresis tank body, a side wall of the electrode holder abuts against a side wall of the electrophoresis tank body.

23. The electrophoresis device according to claim 22, wherein a pressure plate is provided between the gel plate and an inner wall of the electrophoresis tank body; and a first side of the pressure plate abuts against the gel plate, and a second side of the pressure plate abuts against the inner wall of the electrophoresis tank body.

24. The electrophoresis device according to claim 23, wherein an outline structure of the pressure plate is identical to a structure of the first sealing groove, and the pressure plate is configured to cover the first sealing groove.

25. The electrophoresis device according to claim 23, wherein the pressure plate is provided with guide posts, and the electrode holder is provided with guide holes adapted to the guide posts; and alternatively, the pressure plate is provided with the guide holes, and the electrode holder is provided with the guide posts; and the guide posts are respectively inserted into the guide holes.
